(19) United States
(12) Patent Application Publication
(10) Pub. No.: US 2018/0186398 A1
(43) Pub. Date: Jul. 5, 2018

(54) STEERING DEVICE

(71) Applicant: KYB Corporation, Tokyo (JP)

(72) Inventor: Tetsuro SHIMIZU, Aichi (JP)

(21) Appl. No.: 15/736,287

(22) PCT Filed: Jun. 1, 2016
(86) PCT No.: PCT/JP2016/066265

§ 371 Date: Dec. 13, 2017

(30) Foreign Application Priority Data
Jun. 17, 2015 (JP) 2015-122245

(51) Int. Cl. B62D 5/04; B62D 3/12

(52) U.S. Cl. CPC B62D 5/0409; F16H 1/28; B62D 3/123

(57) ABSTRACT

A steering device includes the steering shaft configured to rotate by a steering torque input from the bar handle having a maximum steering angle of 180° or smaller on one side, the pinion gear configured to rotate together with the steering shaft, the rack shaft including the rack gear meshed with the pinion gear and configured to turn the wheels. The pinion gear is coupled as a separate body to the steering shaft.

### TECHNICAL FIELD

The present invention relates to a steering device.

### BACKGROUND ART

JP2005-1605A discloses a rack-and-pinion type steering device in which an output shaft serving as a pinion shaft is coupled to an input shaft, a rack shaft is meshed with the output shaft and a steering force is transmitted to turning wheels.

### SUMMARY OF INVENTION

In the rack-and-pinion type steering device disclosed in JP2005-1605A, a maximum steering angle of a steering handle and a reduction ratio of a rack and pinion are determined according to a desired maximum turning angle of wheels.

In the case of a vehicle having a relatively large maximum steering angle of a steering handle, a maximum turning angle can be adjusted without changing a reduction ratio of a rack and pinion by adjusting the maximum steering angle of the steering handle.

In contrast, in the case of a vehicle in which a maximum steering angle of a steering handle is limited to a relatively small angle, it is difficult to adjust a maximum turning angle only by adjusting the maximum steering angle of the steering handle since the maximum steering angle is limited to the relatively small angle. Thus, in such a case, a reduction ratio of a rack and pinion also needs to be changed.

Accordingly, in the vehicle in which the maximum steering angle of the steering handle is limited to the relatively small angle, the rack and pinion has to be manufactured according to the magnitude of the maximum turning angle and manufacturing cost increases.

The present invention aims to reduce the manufacturing cost of a rack-and-pinion type steering device for turning wheels by a steering handle having a small maximum steering angle.

According to one aspect of the present invention, a steering device includes: a steering shaft configured to rotate by a steering torque input from a steering handle having a maximum steering angle of 180° or smaller on one side; a pinion gear configured to rotate together with the steering shaft; a rack shaft including a rack gear meshed with the pinion gear, the rack shaft being configured to turn wheels; an electric motor configured to apply a rotational torque for assisting the steering torque to the rack shaft; and a speed reducing unit configured to decelerate and transmit the rotation of the electric motor to the rack shaft. The pinion gear is coupled as a separate body to the steering shaft.

### BRIEF DESCRIPTION OF DRAWINGS

FIG. 1 is a configuration diagram of a steering device according to an embodiment of the present invention,

FIG. 2 is a sectional view showing the configuration of an output shaft of the steering device according to the embodiment of the present invention,

FIG. 3 is a sectional view showing the configuration of a speed reducing unit of the steering device according to the embodiment of the present invention, and

FIG. 4 is a sectional view showing a modification of the steering device according to the embodiment of the present invention.

### DESCRIPTION OF EMBODIMENT

Hereinafter, a steering device 100 according to an embodiment of the present invention is described with reference to the drawings.

The steering device 100 is a device mounted in a vehicle for turning wheels 5 by converting a steering torque applied to a bar handle 1 serving as a steering handle by a driver.

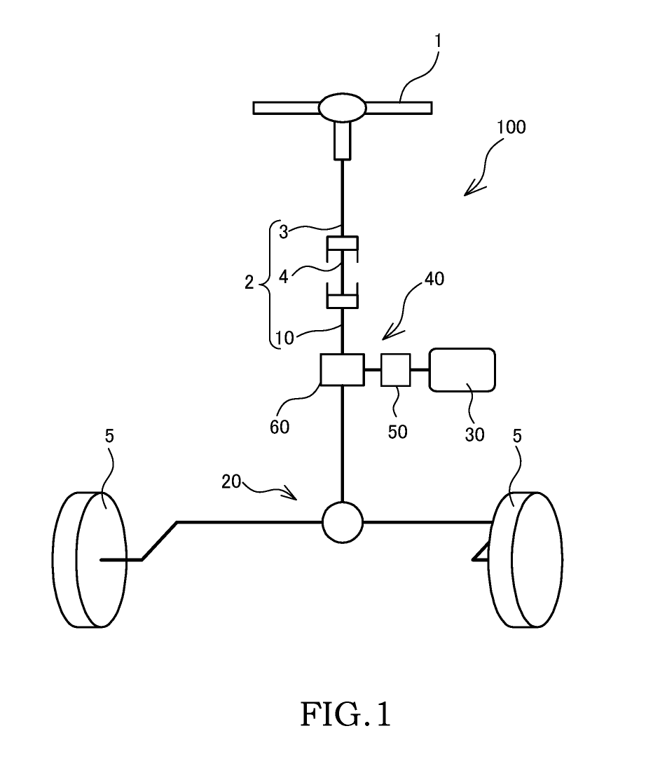

As shown in FIG. 1, the steering device 100 includes a steering shaft 2 configured to rotate by a steering torque input from the bar handle 1, a rack and pinion mechanism 20 configured to turn the wheels 5 by converting the rotation of the steering shaft 2, an electric motor 30 configured to apply a rotational torque for assisting the steering torque to the steering shaft 2 and a speed reducing unit 40 configured to decelerate and transmit the rotation of the electric motor 30 to the steering shaft 2.

The steering torque is input to the bar handle 1 by the operation of a driver. The bar handle 1 is a steering handle steerable within a range of 180° to each of left and right sides from a neutral position. That is, the bar handle 1 is a steering handle whose maximum steering angle is limited to 180° or smaller on one side.

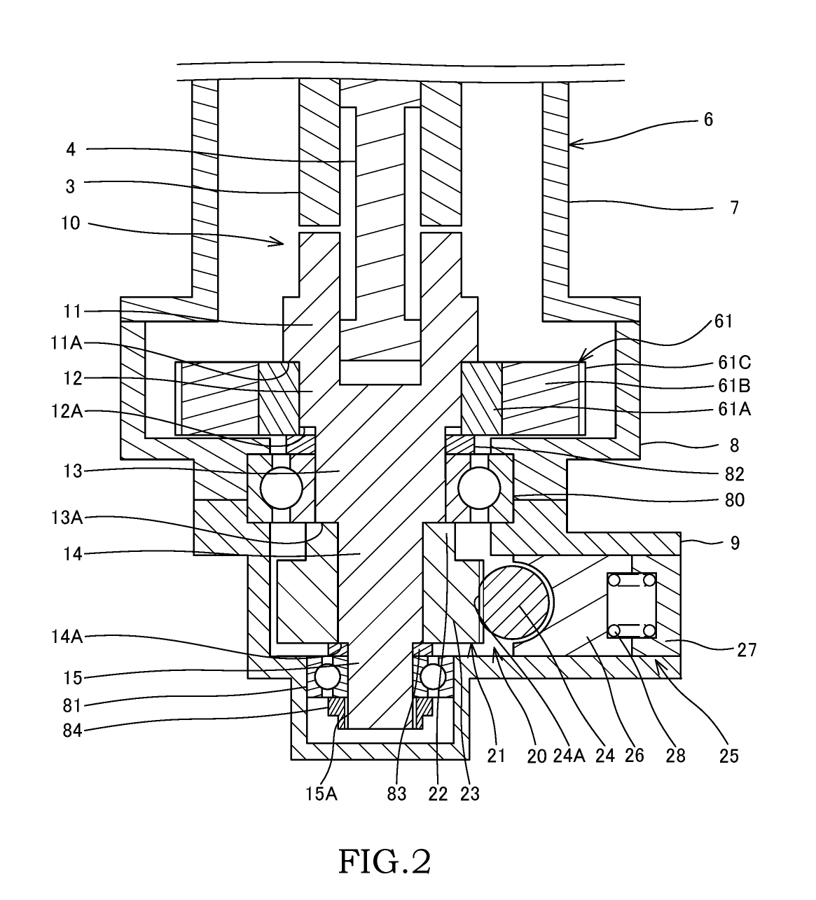

The steering shaft 2 includes an input shaft 3 linked to the bar handle 1 and configured such that a steering torque is transmitted thereto, an output shaft 10 having a lower end linked to the rack and pinion mechanism 20, and a torsion bar 4 coupling the input shaft 3 and the output shaft 10. The steering shaft 2 is housed in a housing 6 (see FIG. 2).

As shown in FIG. 2, the output shaft 10 is coupled to the input shaft 3 via the torsion bar 4 and rotatably supported in the housing 6 via a first shaft bearing 80 and a second shaft bearing 81. The first and second shaft bearings 80, 81 are rolling bearings.

The housing 6 for housing the steering shaft 2 includes a shaft case 7 configured to house the input shaft 3, a gear case 8 configured to house the speed reducing unit 40 and a rack case 9 configured to house the rack and pinion mechanism 20.

The rack and pinion mechanism 20 includes a pinion gear 21 formed separately from the output shaft 10, coupled to the output shaft 10 and configured to rotate according to the rotation of the output shaft 10, and a rack shaft 24 having a rack gear 24A meshed with the pinion gear 21 and configured to turn the wheels 5.

The rack shaft 24 is biased toward the pinion gear 21 by a supporting mechanism 25 provided in the rack case 9. The supporting mechanism 25 includes a pressure pad 26 configured to slide in contact with the rack shaft 24, an adjuster cover 27 threadably engaged with the rack case 9 and a spring 28 interposed in a compressed state between the pressure pad 26 and the adjuster cover 27 and configured to bias the pressure pad 26 toward the pinion gear 21. By changing a position at which the adjuster cover 27 is threadably engaged, a set load of the spring 28 is adjusted to adjust a biasing force to the rack shaft 24. By biasing the rack shaft 24 toward the pinion gear 21, backlash between the rack shaft 24 and the pinion gear 21 is reduced, thereby reducing rattling noise when the pinion gear 21 rotates and the rack shaft 24 moves.

The output shaft 10 rotates by a steering torque input to the bar handle 1 by the operation of the driver transmitted thereto via the input shaft 3 and the torsion bar 4. The pinion gear 21 meshed with the rack gear 24A of the rack shaft 24 rotates according to the rotation of the output shaft 10, whereby the rack shaft 24 linearly moves. By the linear motion of the rack shaft 24, the wheels 5 are turned via tie rods (not shown). As just described, the rotation of the output shaft 10 is converted into a linear motion by the rack and pinion mechanism 20, whereby the wheels 5 are turned.

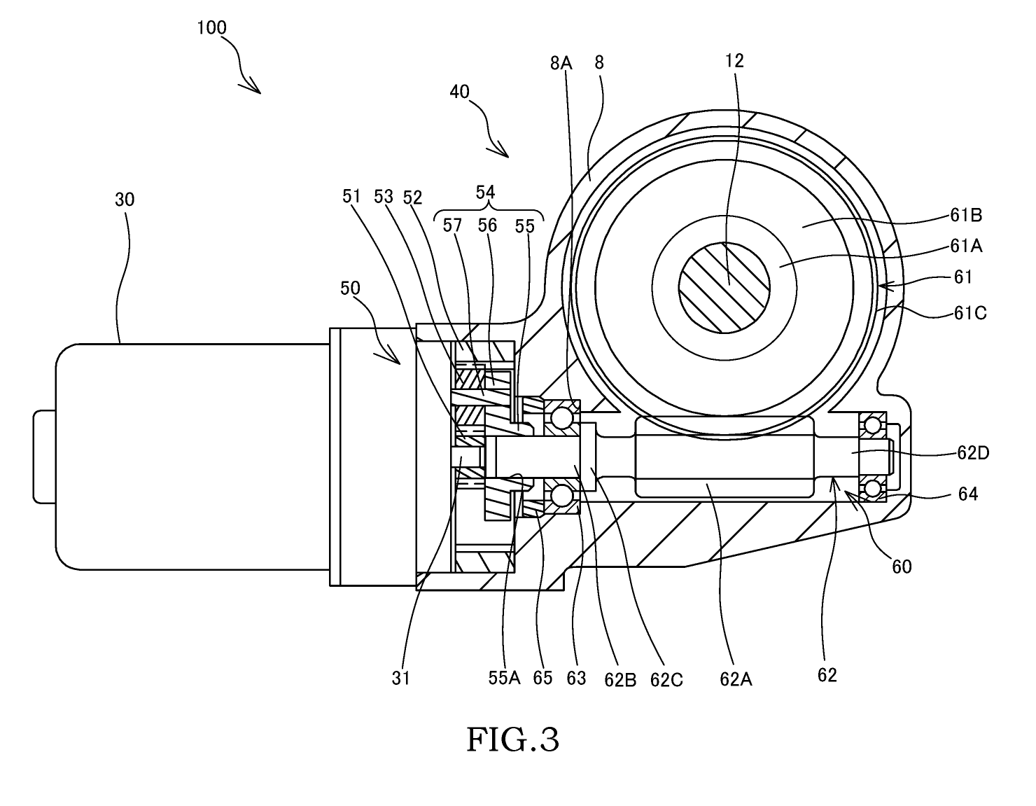

The electric motor 30 is a power source for applying a rotational torque for assisting the steering of the bar handle 1 by the driver. The rotational torque output from a rotary shaft 31 (see FIG. 3) of the electric motor 30 is calculated by a controller (not shown) on the basis of a torsion amount of the torsion bar 4 twisted by the operation of the bar handle 1 by the driver detected by a torque sensor (not shown). The rotational torque output by the electric motor 30 is decelerated and transmitted as an assist force to the output shaft 10 of the steering shaft 2 by the speed reducing unit 40. As just described, the electric motor 30 is driven on the basis of a detection result of the torque sensor for detecting a steering torque input from the bar handle 1, and applies a rotational torque to the rack shaft 24 of the rack and pinion mechanism 20 via the steering shaft 2. Thus, the steering of the bar handle 1 by the driver is assisted by the electric motor 30.

As shown in FIG. 3, the speed reducing unit 40 includes a first speed reducing unit 50 configured to decelerate and output the rotation of the electric motor 30 and a second speed reducing unit 60 configured to decelerate and transmit an output of the first speed reducing unit 50 to the output shaft 10. The first speed reducing unit 50 is a planetary gear mechanism coupled to the rotary shaft 31 of the electric motor 30. The second speed reducing unit 60 is a worm gear mechanism including a worm wheel 61 and a worm shaft 62 meshed with the worm wheel 61. The worm wheel 61 of the second speed reducing unit 60 is press-fitted to a press-fit portion 12 of the output shaft 10 to be described later to transmit an output of the second speed reducing unit 60 to the output shaft 10. The configurations of the first and second speed reducing units 50, 60 are specifically described later.

Next, the configuration of the output shaft 10 is specifically described.

As shown in FIG. 2, the worm wheel 61 of the second speed reducing unit 60, the first shaft bearing 80, the pinion gear 21 of the rack and pinion mechanism 20 and the second shaft bearing 81 (hereinafter, these are referred to as “mounting components” if necessary) are mounted from an upper end on the outer periphery of the output shaft 10. The mounting components are mounted, from the upper component successively, on the outer periphery of the output shaft 10 from the lower end of the output shaft 10.

The output shaft 10 includes a large diameter portion 11, the press-fit portion 12 to which the worm wheel 61 of the second speed reducing unit 60 is press-fitted, the press-fit portion 12 having an outer diameter smaller than the large diameter portion 11, a first supporting portion 13 on which the first shaft bearing 80 mounted, the first supporting portion 13 having an outer diameter smaller than the press-fit portion 12, a coupling portion 14 to which the pinion gear 21 of the rack and pinion mechanism 20 coupled, the coupling portion 14 having an outer diameter smaller than the first supporting portion 13 and a second supporting portion 15 on which the second shaft bearing 81 mounted, the second supporting portion 15 having an outer diameter smaller than the coupling portion 14. The large diameter portion 11, the press-fit portion 12, the first supporting portion 13, the coupling portion 14 and the second supporting portion 15 are successively provided from the upper end to the lower end on the output shaft 10. That is, the outer diameter of the large diameter portion 11 is a maximum outer diameter of the output shaft 10. As just described, the output shaft 10 is formed into a stepped shape whose outer diameter is reduced in a stepwise manner toward an axial tip part (lower end part).

A first step 11A is formed between the large diameter portion 11 and the press-fit portion 12. A second step 12A is formed between the press-fit portion 12 and the first supporting portion 13. The worm wheel 61 is press-fitted to the press-fit portion 12 until coming into contact with the first step 11A from an axial lower end side of the output shaft 10. In this way, the worm wheel 61 is positioned to be meshed with the worm shaft 62. The worm wheel 61 is formed to have a longer axial length than the press-fit portion 12 and projects in an axial direction from the second step 12A.

Between the worm wheel 61 and the first shaft bearing 80, an annular first collar member 82 is provided in contact with both. The first collar member 82 is formed to have an outer diameter larger than an inner diameter of the worm wheel 61.

The first shaft bearing 80 is sandwiched between the gear case 8 and the rack case 9 and rotatably supports the first supporting portion 13 of the output shaft 10.

A third step 13A is formed between the first supporting portion 13 and the coupling portion 14. The pinion gear 21 includes a contact portion 22 configured to come into contact with the third step 13A and a body portion 23 meshed with the rack gear 24A of the rack shaft 24. The pinion gear 21 is inserted from the lower end of the output shaft 10, press-fitted to the coupling portion 14 and positioned by the contact of the contact portion 22 with the third step 13A. As just described, the pinion gear 21 is positioned at a position where the body portion 23 is meshed with the rack gear 24A of the rack shaft 24, and is coupled to the coupling portion 14.

An outer diameter of the body portion 23 of the pinion gear 21 is larger than that of the press-fit portion 12 of the output shaft 10. More specifically, the outer diameter of the body portion 23 is larger than that of the large diameter portion 11 having a larger outer diameter than the press-fit portion 12, i.e. larger than the maximum outer diameter of the output shaft 10. By forming the body portion 23 of the pinion gear 21 to have a large outer diameter in this way, a movement amount of the rack shaft 24 can be increased by reducing a reduction ratio even if the bar handle 1 has a relatively small maximum steering angle of 180° or smaller on one side.

A fourth step 14A is formed between the coupling portion 14 and the second supporting portion 15. Between the pinion gear 21 and the second shaft bearing 81, an annular second collar member 83 is provided in contact with both. The second collar member 83 is formed to have an outer diameter larger than an inner diameter of the pinion gear 21.

The second shaft bearing 81 is inserted onto the output shaft 10 from the lower end of the output shaft 10 until coming into contact with the fourth step 14A via the second collar member 83.

An external thread 15A is formed on the tip of the second supporting portion 15. A nut member 84 is threadably engaged with the external thread 15A and comes into contact with the second shaft bearing 81. By a fastening force of the nut member 84 to the external thread 15A, all the mounting components adjacent to each other in the axial direction are sandwiched and positioned by the output shaft 10 and the nut member 84 via the first and second collar members 82, 83. In this way, the mounting components are mounted on the output shaft 10. Specifically, by threadably engaging the nut member 84 with the tip of the second supporting portion 15, each mounting component provided on the outer periphery of the output shaft 10 is positioned and restricted so as not to come off the output shaft 10.

The rack case 9 is attached to the gear case 8 after the nut member 84 is threadably engaged with the second supporting portion 15 and all the mounting components are mounted on the output shaft 10. The rack case 9 rotatably supports the output shaft 10 via the second shaft bearing 81.

Here, in a rack-and-pinion type steering device, a maximum steering angle of a steering handle and a reduction ratio of a rack and pinion are determined according to a desired maximum turning angle of wheels. Thus, it is thought to adjust the maximum steering angle of the steering handle and change a movement amount of a rack shaft by changing the reduction ratio of the rack and pinion mechanism when a maximum turning angle of the wheels differs in each vehicle type or in order to adjust a maximum turning angle of the vehicle.

In ATVs (All Terrain Vehicles) such as buggy vehicles and vehicles in which an accelerator and a brake are provided near a steering handle, a maximum steering angle of the steering handle is limited to a relatively small angle of 180° or smaller on one side. If the maximum steering angle of the steering handle is relatively small, an angle of rotation of an output shaft is small and a movement amount of a rack shaft per unit steering angle is large. Thus, even if an adjustment amount of the maximum steering angle is small, a maximum turning angle largely changes. Therefore, the maximum steering angle has to be adjusted with high accuracy to set a desired maximum turning angle, and it is difficult to adjust the maximum turning angle of the wheels to a desired one by adjusting the maximum steering angle of the steering handle. Further, since the maximum steering angle is limited to the small angle, a maximum steering angle larger than the limited angle cannot be set. Thus, in the case of a vehicle having a relatively small maximum steering angle, a reduction ratio of a rack and pinion mechanism has to be changed in some cases to set a desired maximum turning angle.

In vehicles having a relatively small maximum steering angle of a steering handle, a reduction ratio of a rack and pinion mechanism needs to be set smaller than in vehicles having a large maximum steering angle in order to increase a movement amount of a rack shaft. However, if the reduction ratio is excessively reduced, an outer diameter of a pinion gear may become larger than those of other parts of an output shaft such as a press-fit portion formed to have a large diameter, for example, since a rotational torque is transmitted thereto via a worm wheel.

In the case of integrally forming an output shaft and a pinion gear, the output shaft has to be formed of a material matching an outer diameter of the pinion gear in order to make the pinion gear larger than outer diameters of other parts of the output shaft, and a diameter of a material before processing is large. Further, in the case of integrally forming the pinion gear and the output shaft, output shafts differing only in the shape of the pinion gear having to be manufactured according to the maximum turning angle of the wheels, wherefore the number of components and the number of manufacturing steps increase. Therefore, manufacturing cost increases of a steering device of a vehicle equipped with a steering handle having a small maximum steering angle includes an output shaft integrally formed to a pinion gear.

In contrast, since the pinion gear 21 is a separate component to be coupled to the coupling portion 14 of the output shaft 10 in the steering device 100, the pinion gear 21 can be formed separately from the output shaft 10. Thus, even if the pinion gear 21 has a larger outer diameter than the press-fit portion 12 and the large diameter portion 11, the output shaft 10 can be commonly used regardless of the size of the pinion gear 21 and a diameter of a material before processing needs not be large. Hence, the output shaft 10 and the pinion gear 21 can be easily formed at low cost as compared to the case where the output shaft 10 and the pinion gear 21 are integrally formed. Therefore, even in vehicles having different maximum turning angle of the wheels 5, a movement amount of the rack shaft 24 can be easily adjusted without adjusting the maximum steering angle of the bar handle 1 with high accuracy by exchanging only the pinion gear 21. As described above, even if the maximum turning angle differs in each vehicle type or the maximum turning angle of the vehicle is adjusted, the common output shaft 10 can be used and the manufacturing cost of the steering device 100 can be reduced.

Further, since the pinion gear 21 is a separate component to be coupled to the output shaft 10, the output shaft 10 and the pinion gear 21 can be formed of different materials. Thus, the cost of the steering device 100 can be further reduced while durability is ensured by forming the pinion gear 21 of a material with a high wear resistance and forming the output shaft 10 of a relatively inexpensive material.

Further, the output shaft 10 is formed into a stepped shape whose outer diameter is reduced from the upper end to the lower end and the mounting components are formed to have inner diameters corresponding to the outer diameter of the output shaft 10. That is, the inner diameter of the worm wheel 61 on the upper end side is largest and the inner diameters of the components become smaller toward the lower end side. Thus, the components can be successively inserted from the one to be located on the upper end side from the lower end of the output shaft 10 with sufficient clearances formed between the components and the outer periphery of the output shaft 10. Therefore, the steering device 100 can be easily assembled. Further, since the steering device 100 is easily assembled, the pinion gear 21 is easily exchanged.

Next, the configurations of the first and second speed reducing units 50, 60 are specifically described with reference to FIG. 3.

As shown in FIG. 3, the first speed reducing unit 50 is a planetary gear mechanism including a sun gear 51 to be coupled to the rotary shaft 31 of the electric motor 30, a ring gear 52 provided outside the sun gear 51 and to be fixed to the gear case 8, a plurality of planetary gears 53 provided between the sun gear 51 and the ring gear 52 and meshed with each of the sun gear 51 and the ring gear 52, and a carrier 54 coupling the plurality of planetary gears 53 to each other.

The plurality of planetary gears 53 are provided at equal angular intervals outside the sun gear 51 and meshed with each of the sun gear 51 and the ring gear 52. When the sun gear 51 rotates according to the rotation of the electric motor 30, the planetary gears 53 revolve around the sun gear 51. In FIG. 3, only one planetary gear 53 is shown and the other planetary gears 53 are not shown.

The carrier 54 includes a tubular portion 55 having a through hole 55A in a central part, a flange portion 56 provided to radially project from an end part of the tubular portion 55 and a plurality of coupling pins 57 provided on the flange portion 56 and to be respectively press-fitted into the plurality of planetary gears 53.

The worm wheel 61 of the second speed reducing unit 60 includes a metal core 61A made of metal and to be press-fitted to the press-fit portion 12 of the output shaft 10, and a resin portion 61B molded around the metal core 61A and having a tooth portion 61C formed on the outer periphery thereof. In the worm wheel 61, the tooth portion 61C may be formed on the outer periphery of the resin portion 61B after the resin portion 61B is molded around the metal core 61A or the resin portion 61B having the tooth portion 61C formed thereon may be press-fitted to the metal core 61A.

The worm shaft 62 of the second speed reducing unit 60 is formed with a tooth portion 62A meshed with the tooth portion 61C of the worm wheel 61. The worm shaft 62 is housed into the gear case 8 coaxially with the rotary shaft 31 of the electric motor 30 and one end 62B is inserted into the through hole 55A of the carrier 54 in the first speed reducing unit 50 to be serration-connected.

The worm shaft 62 has both ends rotatably supported by a pair of worm bearings 63, 64. The worm bearing 63 supporting the one end 62B of the worm shaft 62 on the side of the electric motor 30 is held between a lock nut 65 provided side by side with the worm bearing 63 in an axial direction and a step portion 8A formed in the gear case 8. Further, the worm shaft 62 on a side opposite to the lock nut 65 across the worm bearing 63 is formed with a locking portion 62C having an outer diameter larger than an inner diameter of the worm bearing 63. Another end 62D of the worm shaft 62 is formed into a stepped shape and comes into contact with the other worm bearing 64. In this way, a movement of the worm shaft 62 in the axial direction is restricted.

The tubular portion 55 of the carrier 54 in the first speed reducing unit 50 is formed to have an outer diameter smaller than an inner diameter of the lock nut 65 holding the worm bearing 63 supporting the one end 62B of the worm shaft 62, and housed inside the lock nut 65. Since a coupling length of the carrier 54 and the worm shaft 62 is increased in this way, a larger force can be transmitted from the first speed reducing unit 50 to the second speed reducing unit 60. Further, by housing the tubular portion 55 inside the lock nut 65, an axial length of the entire speed reducing unit 40 can be shortened and the speed reducing unit 40 is reduced in size.

When the electric motor 30 is driven to rotate the rotary shaft 31, the sun gear 51 of the first speed reducing unit 50 rotates. According to the rotation of the sun gear 51, the planetary gears 53 revolve around the sun gear 51 while being meshed with each of the ring gear 52 and the sun gear 51. In this way, the rotation of the electric motor 30 is decelerated at a reduction ratio corresponding to tooth numbers of the sun gear 51 and the ring gear 52, and output as the rotation of the carrier 54.

According to the rotation of the carrier 54, the worm shaft 62 of the second speed reducing unit 60 rotates. According to the rotation of the worm shaft 62, the worm wheel 61 rotates while being decelerated at a reduction ratio corresponding to a tooth number of the tooth portion 62A in the worm shaft 62 and a tooth number of the tooth portion 61C in the worm wheel 61. Thus, the rotation of the worm shaft 62 is decelerated at the reduction ratio corresponding to the tooth number of the tooth portion 62A in the worm shaft 62 and the tooth number of the tooth portion 61C in the worm wheel 61 and transmitted to the output shaft 10.

As just described, the rotation of the electric motor 30 is decelerated at the reduction ratio corresponding to the tooth numbers of the sun gear 51 and the ring gear 52 by the first speed reducing unit 50, further decelerated at the reduction ratio corresponding to the tooth numbers of the worm shaft 62 and the worm wheel 61 and transmitted to the output shaft 10. Thus, the steering device 100 can apply a large rotational torque to the output shaft 10 by the electric motor 30 and can improve a steering torque assist force by the electric motor 30.

If the steering handle is the bar handle 1, a turning force for the wheels 5 may be insufficient in the case of steering a vehicle having a large maximum steering angle of the wheels 5 or a vehicle having a large weight since a steering torque input from the bar handle 1 is small.

In contrast, since two speed reducing units, i.e. the first and second speed reducing units 50, 60, are provided between the electric motor 30 and the output shaft 10 in the steering device 100, a large rotational torque can be applied to the output shaft 10 by the electric motor 30. Thus, even if the steering handle is the bar handle 1, a large rotational torque can be applied as an assist force to the steering shaft 2 by the small-size electric motor 30 and a sufficient turning force can be ensured according to the steering device 100. Therefore, the bar handle 1 can be used even in a vehicle having a large maximum steering angle of the wheels 5 or a vehicle having a large weight.

Further, by using the bar handle 1 as a steering handle, foot-operated components such as an accelerator pedal and a brake pedal can be integrated with the bar handle 1. Thus, in the steering device 100, even if the steering handle is the bar handle 1, a turning force for the wheels 5 can be ensured and space saving can be realized in a vehicle front part.

Further, since the steering device 100 includes the first and second speed reducing units 50,60 configured to decelerate the rotation of the electric motor 30, a large assist force is applied to the output shaft 10 without enlarging the electric motor 30 by driving the electric motor 30 at a high rotational speed. Therefore, the electric motor 30 can be reduced in size and the amount of power consumption in the steering device 100 can be suppressed.

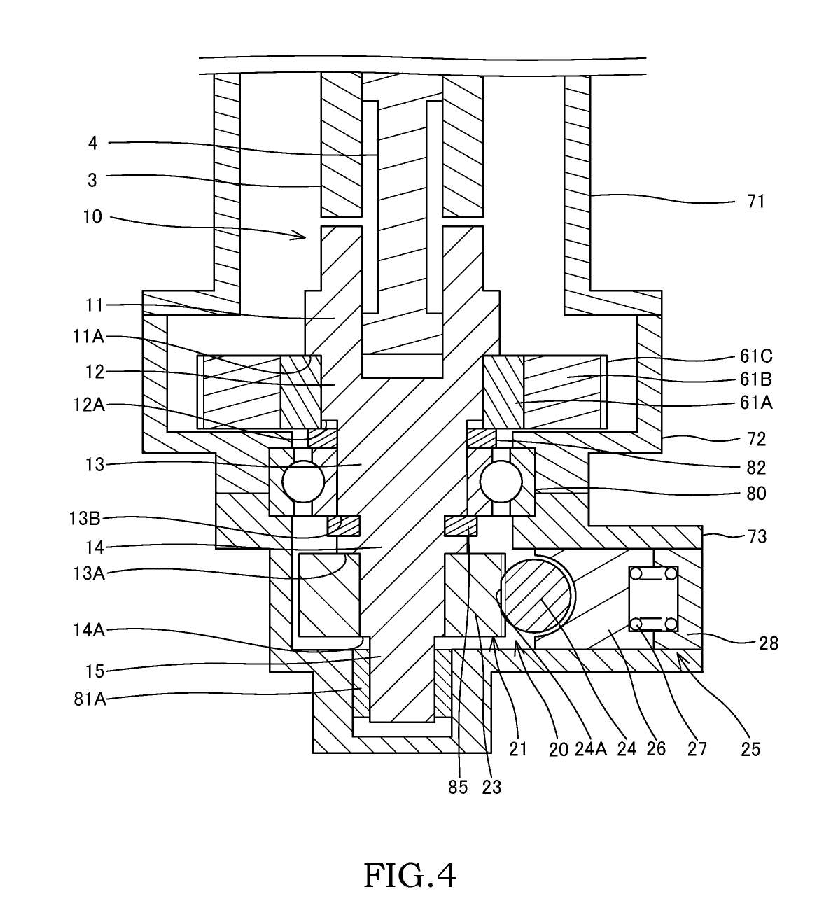

Next, a modification of the above embodiment is described with reference to FIG. 4.

In the above embodiment, the pinion gear 21 includes the contact portion 22 configured to come into contact with the third step 13A and the body portion 23 meshed with the rack gear 24A. Instead of this, the pinion gear 21 may be composed only of the body portion 23 without including the contact portion 22 and the body portion 23 may directly come into contact with the third step 13A of the output shaft 10 as shown in FIG. 4.

Further, in the above embodiment, the pinion gear 21 is coupled to the coupled portion 14 to rotate together with the output shaft 10 by being press-fitted to the coupled portion 14. Instead of this, the pinion gear 21 may be detachably coupled to the coupled portion 14 by spline connection or serration connection. Further, the pinion gear 21 may be undetachably mounted on the coupled portion 14 by crimping a part of the output shaft 10 after being coupled to the coupled portion 14 by spline connection or serration connection. As just described, the pinion gear 21 may be detachable or may be undetachable as long as the pinion gear 21 is coupled to the coupled portion 14 to rotate together with the output shaft 10.

Further, in the above embodiment, the rotational torque of the electric motor 30 decelerated by the speed reducing unit 40 is transmitted to the output shaft 10 of the steering shaft 2 and transmitted to the rack shaft 24 via the output shaft 10. Instead of this, the rotational torque of the electric motor 30 may be applied to the rack shaft 24, for example, by another pinion gear different from the above pinion gear 21 meshed with the rack gear 24A of the rack shaft 24 or a belt and a pulley without being transmitted to the steering shaft 2.

Further, the second shaft bearing 81, which is a rolling bearing, may be a sliding bearing 81A to be press-fitted into the rack case 9. In this case, since it is not necessary to provide the nut member 84 for retaining the second shaft bearing 81, the number of components constituting the steering device 100 is reduced.

Further, the first supporting portion 13 may be provided with an annular groove 13B and the first shaft bearing 80 may be positioned by a locking ring 85 housed in the annular groove 13B.

Further, in the above embodiment, the first speed reducing unit 50 is a planetary gear mechanism and the second speed reducing unit 60 is a worm gear mechanism. Instead of this, the first and second speed reducing units 50, 60 may be, for example, other gear mechanisms including spur gears, bevel gears and the like.

Further, in the above embodiment, the speed reducing unit 40 decelerates and transmits the rotation of the electric motor 30 to the steering shaft 2 using two speed reducing units, i.e. the first and second speed reducing units 50, 60. Instead of this, the speed reducing unit 40 may include a single speed reducing unit or may include three or more speed reducing units.

Further, in the above embodiment, the steering handle is the bar handle 1. Instead of this, another steering handle such as a steering wheel or a control stick may be, for example, used if a maximum steering angle is 180° or smaller on one side.

According to the above embodiment, the following effects are exhibited.

In the steering device 100, the pinion gear 21 is a separate component to be coupled to the coupling portion 14 of the output shaft 10. Thus, the pinion gear 21 having the outer diameter larger than the outer diameters of the other parts of the output shaft 10 such as the press-fit portion 12 can be easily formed at low cost as compared to the case where the output shaft 10 and the pinion gear 21 are integrally formed. Since a movement amount of the rack shaft 24 can be easily adjusted only by exchanging the pinion gear 21 in this way, the common output shaft 10 can be used even in vehicles having different maximum turning angles. Thus, the manufacturing cost of the steering device 100 is reduced.

Further, the output shaft 10 is formed into a stepped shape whose outer diameter is reduced from the upper end to the lower end and the mounting components are formed to have inner diameters corresponding to the outer diameter of the output shaft 10. Thus, the components can be successively inserted from the one to be located on the upper end side from the lower end of the output shaft 10 with sufficient clearances formed between the components and the outer periphery of the output shaft 10. Hence, the steering device 100 can be easily assembled. Therefore, the pinion gear 21 can be easily exchanged and the movement amount of the rack shaft 24 can be easily adjusted.

Further, according to the steering device 100, the rotation of the electric motor 30 is decelerated by the first and second speed reducing units 50, 60, whereby a large rotational torque is applied to the output shaft 10 to improve an assist force. Thus, even if the steering angle of the steering handle is small, a large rotational torque is applied as an assist force to the steering shaft 2 by the small-size electric motor 30 and a turning force can be ensured. Therefore, in the steering device 100, a turning force for the wheels 5 can be ensured even with the bar handle 1 difficult to increase the reduction ratio because the foot-operated components such as an accelerator pedal and a brake pedal are integrated for space saving and the maximum steering angle is limited to a small angle.

The configuration, functions and effects of the embodiment of the present invention are summarized below.

The steering device 100 includes the steering shaft 2 configured to rotate by a steering torque input from the bar handle 1 having a maximum steering angle of 180° or smaller on one side, the pinion gear 21 configured to rotate together with the steering shaft 2, the rack shaft 24 including the rack gear 24A meshed with the pinion gear 21 and configured to turn the wheels 5, the electric motor 30 configured to apply a rotational torque for assisting the steering torque to the rack shaft 24 via the steering shaft 2, and the speed reducing unit 40 configured to decelerate and transmit the rotation of the electric motor 30 to the rack shaft 24 via the steering shaft 2, and the pinion gear 21 is coupled as a separate body to the steering shaft 2.

Since the pinion gear 21 is coupled as a separate body to the steering shaft 2 in this configuration, a movement amount of the rack shaft 24 in relation to a steering angle is easily adjusted by exchanging only the pinion gear 21. Thus, the common output shaft 10 can be used in the steering device 100. Therefore, the manufacturing cost of the rack-and-pinion type steering device 100 for turning the wheels 5 by the bar handle 1 having a small maximum steering angle can be reduced.

Further, the steering device 100 includes the input shaft 3 linked to the bar handle 1 within the steering shaft 2 configured such that the steering torque is transmitted thereto, and the output shaft 10 coupled to the input shaft 3 and having the pinion gear 21 coupled to the tip thereof, and the output shaft 10 is formed into a stepped shape whose outer diameter is reduced toward the tip to which the pinion gear 21 is to be coupled.

In this configuration, the components to be provided on the outer periphery of the output shaft 10 can be inserted with sufficient clearances formed between the components and the outer periphery of the output shaft 10 by inserting the components from the tip of the output shaft 10. Thus, the steering device 100 can be easily assembled.

Further, in the steering device 100, the speed reducing unit 40 (second speed reducing unit 60) includes the worm wheel 61 to be press-fitted to the press-fit portion 12 formed on the output shaft 10, the rotation of the electric motor 30 is transmitted to the output shaft 10 via the worm wheel 61 and the outer diameter of the pinion gear 21 is larger than that of the press-fit portion 12 of the output shaft 10.

Further, in the steering device 100, the output shaft 10 includes the large diameter portion 11 having a maximum outer diameter on the output shaft 10 larger than the outer diameter of the press-fit portion 12 and forming the first step 11A between the large diameter portion 11 and the press-fit portion 12, with which the worm wheel 61 comes into contact in an axial direction, and the outer diameter of the pinion gear 21 is larger than that of the large diameter portion 11.

Further, in the steering device 100, the outer diameter of the pinion gear 21 is larger than that of the large diameter portion 11 of the output shaft 10.

According to these configurations, since the pinion gear 21 is coupled as a separate body to the output shaft 10, even the pinion gear 21 having a large outer diameter can be coupled to the common output shaft 10 and the rack and pinion mechanism 20 can be easily configured.

Further, in the steering device 100, the speed reducing unit 40 includes the first speed reducing unit 50 configured to decelerate and output the rotation of the electric motor 30 and the second speed reducing unit 60 configured to decelerate and transmit the output of the first speed reducing unit 50 to the output shaft 10.

In this configuration, the rotation of the electric motor 30 is decelerated by the first and second speed reducing units 50, 60, whereby a large rotational torque is applied to the output shaft 10 to improve an assist force. Thus, even if the steering angle of the steering handle is small, a large rotational torque can be applied as an assist force to the steering shaft 2 by the small-size electric motor 30 and a turning force can be ensured.

Further, in the steering device 100, the pinion gear 21 includes the body portion 23 meshed with the rack gear 24A of the rack shaft 24 and the contact portion 22 configured to position the pinion gear 21 by coming into contact with the third step 13A of the output shaft 10 in the axial direction.

Further, the steering device 100 further includes the nut member 84 configured to threadably engage the external thread 15A formed on the tip of the output shaft 10, and the pinion gear 21 is positioned and restricted so as not to come off the output shaft 10 by the nut member 84.

Embodiments of this invention were described above, but the above embodiments are merely examples of applications of this invention, and the technical scope of this invention is not limited to the specific constitutions of the above embodiments.

This application claims priority based on Japanese Patent Application No. 2015-122245 filed with the Japan Patent Office on Jun. 17, 2015, the entire contents of which are incorporated into this specification.

1. A steering device, comprising:
a steering shaft configured to rotate by a steering torque input from a steering handle having a maximum steering angle of 180° or smaller on one side;
a pinion gear configured to rotate together with the steering shaft;
a rack shaft including a rack gear meshed with the pinion gear, the rack shaft being configured to turn wheels;
an electric motor configured to apply a rotational torque for assisting the steering torque to the rack shaft; and
a speed reducing unit configured to decelerate and transmit the rotation of the electric motor to the rack shaft, wherein
the pinion gear is coupled as a separate body to the steering shaft.

2. The steering device according to claim 1, wherein:
the steering shaft includes:
an input shaft linked to the steering handle, the steering torque being transmitted to the input shaft; and
an output shaft coupled to the input shaft, the pinion gear being coupled to a tip part of the output shaft; and
the output shaft is formed into a stepped shape whose outer diameter is reduced toward the tip part configured such that the pinion gear is coupled thereto.

3. The steering device according to claim 2, wherein:
the speed reducing unit includes a worm wheel to be press-fitted to a press-fit portion formed on the output shaft and the rotation of the electric motor is transmitted to the output shaft via the worm wheel; and
the outer diameter of the pinion gear is larger than an outer diameter of the press-fit portion of the output shaft.

4. The steering device according to claim 3, wherein:
the output shaft includes a large diameter portion having a maximum outer diameter on the output shaft larger than the outer diameter of the press-fit portion, the output shaft forming a step between the large diameter portion and the press-fit portion, the worm wheel coming into contact with the step in an axial direction; and
the outer diameter of the pinion gear is larger than the outer diameter of the large diameter portion.

5. The steering device according to claim 2, wherein:
the outer diameter of the pinion gear is larger than a maximum outer diameter of the output shaft.

6. The steering device according to claim 1, wherein the speed reducing unit includes:
a first speed reducing unit configured to decelerate and output the rotation of the electric motor; and
a second speed reducing unit configured to decelerate and transmit an output of the first speed reducing unit to the steering shaft.

7. The steering device according to claim 2, wherein:
the pinion gear includes a body portion meshed with the rack gear of the rack shaft and a contact portion configured to position the pinion gear by coming into contact with the output shaft in an axial direction.

8. The steering device according to claim 2, further comprising:
a nut member configured to threadably engage an external thread formed on a tip of the output shaft,
wherein the pinion gear is positioned and restricted so as not to come off the output shaft by the nut member.
